(19) United States
(12) Patent Application Publication
(10) Pub. No.: US 2026/0238996 A1
(43) Pub. Date: Aug. 13, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Zhengyi SHANG, Beijing (CN); Wei LU, Beijing (CN)

(73) Assignee: Beijing Xiaomi Mobile Software Co., Ltd., Beijing (CN)

(21) Appl. No.: 19/154,191

(22) PCT Filed: Feb. 8, 2023
(86) PCT No.: PCT/CN2023/075082

§ 371 Date: Aug. 6, 2025

(51) Int. Cl. H04W 12/03; H04W 12/0431; H04W 12/69; H04W 76/14; H04W 92/18

(52) U.S. Cl. CPC H04W 12/03; H04W 12/0431; H04W 12/69; H04W 76/14; H04W 92/18

(57) ABSTRACT

A system and method for secure information processing in direct communication scenarios involving user equipment (UE) devices, including first, relay, and second UEs. The method enables a first UE to send a direct communication request (DCR) to a relay UE, where the DCR includes privacy information comprising identification information (ID) and, optionally, a relay service code (RSC), both encrypted using a key stream derived from a key and parameters such as time-based counters, bearer information, direction indicators, or message length. The relay UE decrypts the received DCR, compares the extracted ID and/or RSC with stored values, and conditionally establishes or aborts a direct communication interface (PC5 link) with the first UE. The relay UE may then forward a second DCR to a second UE, using a similarly encrypted ID and optional RSC. The described techniques enhance privacy and authentication in decentralized UE-to-UE communication environments.

### CROSS-REFERENCE TO RELATED APPLICATIONS

The present application is a U.S. National Stage of International Application No. PCT/CN2023/075082, filed on Feb. 8, 2023, the content of which is incorporated by reference herein in its entirety for all purposes.

### TECHNICAL FIELD

The present disclosure relates to the field of wireless communication technology but is not limited to the field of wireless communication technology, and in particular to an information processing method and apparatus, a communication device and a storage medium.

### BACKGROUND

In the related art, the source user equipment (UE) can obtain the identification information (ID) of the target UE for subsequent communication. In the UE-to-UE (U2U) relay scenario, in order to establish a direct communication interface (PC5 link) between the source UE and the relay UE as well as between the relay UE and the target UE, a direct communication request (DCR) message, etc. can be sent between the source UE and the relay UE as well as between the relay UE and the target UE. However, if the communication between the source UE and the relay UE, and/or between the relay UE and the target UE is not protected, it is easy to cause the leakage of UE privacy information, which poses a great security risk.

### SUMMARY

The embodiments of the present disclosure provide information processing method and apparatus, a communication device and a storage medium.

According to a first aspect of the embodiments of the present disclosure, there is provided an information processing method, performed by a first user equipment (UE), including:

sending a first direct communication request DCR to a relay UE, where the first DCR includes first privacy information; the first privacy information includes first identification information ID encrypted based on a first key stream.

In some embodiments, the first privacy information further includes a relay service code RSC encrypted based on the first key stream.

In some embodiments, the first ID includes at least one of:
ID of the first UE;
ID of the relay UE;
ID of a second UE;
key ID of a first link; where the first link is a link between the first UE and the relay UE.

In some embodiments, the method further includes:
determining the first privacy information by encrypting the first ID based on the first key stream; or
determining the first privacy information by encrypting the first ID and the RSC based on the first key stream.

In some embodiments, the first key stream is determined based on a first key and at least one of:
a Coordinated Universal Time (UTC)-based counter;
a bearer;
direction information; or
length information.

In some embodiments, the first key is determined based on at least one of:
a discovery user confidentiality key (DUCK), where the DUCK is configured to encrypt and decrypt the first ID;
a discovery user scrambling key (DUSK), where the DUSK is configured to scramble the first ID;
a long-term credential, where the long-term credential is a root key for establishing a direct communication interface PC5 link.

According to a second aspect of the embodiments of the present disclosure, there is provided an information processing method, performed by a relay user equipment UE, including:
receiving a first direct communication request DCR sent by a first UE, where the first DCR includes first privacy information; the first privacy information includes first identification information ID encrypted based on a first key stream.

In some embodiments, the first privacy information further includes a relay service code RSC encrypted based on the first key stream.

In some embodiments, the first ID includes at least one of:
ID of the first UE;
ID of the relay UE;
ID of a second UE; or
key ID of a first link; wherein the first link is a link between the first UE and the relay UE.

In some embodiments, the method further includes:
obtaining the first ID by decrypting the first DCR based on the first key stream; or
obtaining the first ID and the RSC by decrypting the first DCR based on the first key stream.

In some embodiments, the method further includes one of:
in response to the first ID obtained by decrypting the first DCR being the same as a stored first ID, determining to establish a first PC5 link between the relay UE and the first UE;
in response to the RSC obtained by decrypting the first DCR being the same as a stored RSC, determining to establish the first PC5 link;
in response to the first ID and the RSC obtained by decrypting the first DCR being the same as the stored first ID and the stored RSC, determining to establish the first PC5 link;
in response to the first ID obtained by decrypting the first DCR being different from the stored first ID, determining to abort a first PC5 link establishment procedure;
in response to the RSC obtained by decrypting the first DCR being different from the stored RSC, determining to abort the first PC5 link establishment procedure;
in response to the first ID and the RSC obtained by decrypting the first DCR being different from the stored first ID and the stored RSC, determining to abort the first PC5 link establishment procedure.

In some embodiments, the first DCR includes a layer 2 ID; and the method includes:
in response to the layer 2 ID in the first DCR is the same as a stored layer 2 ID, determining the RSC corresponding to the layer 2 ID based on the layer 2 ID; and
determining the first key stream corresponding to the RSC based on the RSC.

In some embodiments, the method further includes sending a second DCR to a second UE, where the second DCR includes second privacy information; the second privacy information includes second identification information ID encrypted based on a second key stream.

In some embodiments, the second privacy information further includes an RSC encrypted based on the second key stream.

In some embodiments, the second ID includes at least one of:
ID of the first UE;
ID of the relay UE;
ID of the second UE;
key ID of a second link; where the second link is a link between the relay UE and the second UE.

In some embodiments, the method includes one of:
determining the second privacy information by encrypting the second ID based on the second key stream; or
determining the second privacy information by encrypting the second ID and the RSC based on the second key stream.

In some embodiments, the second key stream is determined based on a second key and at least one of:
a UTC-based counter;
a barrier;
direction information; or
length information.

In some embodiments, the second key stream is determined based on at least one of:
a DUCK, where the DUCK is configured to encrypt and decrypt the second ID;
a DUSK, where the DUSK is configured to scramble the second ID;
a long-term credential, where the long-term credential is a root key for establishing a PC5 link.

According to a third aspect of the present disclosure, there is provided an information processing method, performed by a second UE, including:
receiving a second DCR sent by a relay UE, where the second DCR includes second privacy information; the second privacy information includes second ID encrypted based on a second key stream.

In some embodiments, the second privacy information further includes an RSC based on the second key stream.

In some embodiments, the second ID includes at least one of:
ID of a first UE;
ID of the relay UE;
ID of the second UE; or
key ID of a second link; where the second link is a link between the relay UE and the second UE.

In some embodiments, the method further includes:
obtaining the second ID by decrypting the second DCR based on the second key stream; or
obtaining the second ID and the RSC by decrypting the second DCR based on the second key stream.

In some embodiments, the method includes one of:
in response to the second ID obtained by decrypting the second DCR being the same as stored second ID, determining to establish a second direct communication interface PC5 link between the second UE and the relay UE;
in response to the RSC obtained by decrypting the second DCR being the same as a stored RSC, determining to establish the second PC5 link;
in response to the second ID and the RSC obtained by decrypting the second DCR being the same as the stored second ID and the stored RSC, respectively, determining to establish the second PC5 link;
in response to the second ID obtained by decrypting the second DCR being different from the stored second ID, determining to abort a second PC5 link establishment procedure;
in response to the RSC obtained by decrypting the second DCR being different from the stored RSC, determining to abort the second PC5 link;
in response to the second ID and the RSC obtained by decrypting the second DCR being different from the stored second ID and the stored RSC, determining to abort the second PC5 link.

In some embodiments, the second DCR includes a layer 2 ID; and the method includes:
in response to the layer 2 ID in the second DCR being the same as a stored layer 2 ID, determining the RSC corresponding to the layer 2 ID based on the layer 2 ID;
determining the second key stream corresponding to the RSC based on the RSC.

According to a fourth aspect of the embodiments of the present disclosure, there is provided an information processing device, including:
a first sending module, configured to send a first DCR to a relay UE, where the first DCR includes first privacy information; the first privacy information includes first ID encrypted based on a first key stream.

In some embodiments, the first privacy information further includes a relay service code RSC encrypted based on the first key stream.

In some embodiments, the first ID includes at least one of:
ID of the first UE;
ID of the relay UE;
ID of a second UE;
key ID of a first link; where the first link is a link between the first UE and the relay UE.

In some embodiments, the device further includes a first processing module, where
the first processing module is configured to determine the first privacy information by encrypting the first ID based on the first key stream; or
the first processing module is configured to determine the first privacy information by encrypting the first ID and the RSC based on the first key stream.

In some embodiments, the first key stream is determined based on a first key and at least one of:
a UTC-based counter;
a bearer;
direction information; or
length information.

In some embodiments, the first key is determined based on at least one of:
a DUCK, where the DUCK is configured to encrypt and decrypt the first ID;
a DUSK, where the DUSK is configured to scramble the first ID;
a long-term credential, where the long-term credential is a root key for establishing a direct communication interface PC5 link.

According to a fifth aspect of the embodiments of the present disclosure, there is provided an information processing device, including:
a first receiving module, configured to receive a first DCR sent by a first UE, where the first DCR includes first privacy information; the first privacy information includes first ID encrypted based on a first key stream.

In some embodiments, the first privacy information further includes an RSC encrypted based on the first key stream.

In some embodiments, the first ID includes at least one of:
ID of the first UE;
ID of the relay UE;
ID of a second UE; or
key ID of a first link; wherein the first link is a link between the first UE and the relay UE.

In some embodiments, the device further includes a second processing module, where
the second processing module is configured to obtain the first ID by decrypting the first DCR based on the first key stream; or
the second processing module is configured to obtain the first ID and the RSC by decrypting the first DCR based on the first key stream.

In some embodiments, the second processing module is configured to perform one of:
in response to the first ID obtained by decrypting the first DCR being the same as a stored first ID, determining to establish a first PC5 link between the relay UE and the first UE;
in response to the RSC obtained by decrypting the first DCR being the same as a stored RSC, determining to establish the first PC5 link;
in response to the first ID and the RSC obtained by decrypting the first DCR being the same as the stored first ID and the stored RSC, determining to establish the first PC5 link;
in response to the first ID obtained by decrypting the first DCR being different from the stored first ID, determining to abort a first PC5 link establishment procedure;
in response to the RSC obtained by decrypting the first DCR being different from the stored RSC, determining to abort the first PC5 link establishment procedure;
in response to the first ID and the RSC obtained by decrypting the first DCR being different from the stored first ID and the stored RSC, determining to abort the first PC5 link establishment procedure.

In some embodiments, the first DCR includes a layer 2 ID;
the second processing module is configured to, in response to the layer 2 ID in the first DCR is the same as a stored layer 2 ID, determine the RSC corresponding to the layer 2 ID based on the layer 2 ID; and
the second processing module is further configured to determine the first key stream corresponding to the RSC based on the RSC.

In some embodiments, the device further includes a second sending module, configured to send a second DCR to a second UE, where the second DCR includes second privacy information; the second privacy information includes second identification information ID encrypted based on a second key stream.

In some embodiments, the second privacy information further includes an RSC encrypted based on the second key stream.

In some embodiments, the second ID includes at least one of:
ID of the first UE;
ID of the relay UE;
ID of the second UE;
key ID of a second link; where the second link is a link between the relay UE and the second UE.

In some embodiments, the second processing module is configured to determine the second privacy information by encrypting the second ID based on the second key stream;
or, the second processing module is configured to determine the second privacy information by encrypting the second ID and the RSC based on the second key stream.

In some embodiments, the second key stream is determined based on a second key and at least one of:
a UTC-based counter;
a barrier;
direction information; or
length information.

In some embodiments, the second key stream is determined based on at least one of:
a DUCK, where the DUCK is configured to encrypt and decrypt the second ID;
a DUSK, where the DUSK is configured to scramble the second ID;
a long-term credential, where the long-term credential is a root key for establishing
a PC5 link.

According to a sixth aspect of the embodiments of the present disclosure, there is provided an information processing device, including:
a second receiving module, configured to receive a second DCR sent by a relay UE, where the second DCR includes second privacy information; the second privacy information includes second ID encrypted based on a second key stream.

In some embodiments, the second privacy information further includes an RSC based on the second key stream.

In some embodiments, the second ID includes at least one of:
ID of a first UE;
ID of the relay UE;
ID of the second UE; or
key ID of a second link; where the second link is a link between the relay UE and the second UE.

In some embodiments, the device further includes a third processing module, where
the third processing module is configured to obtain the second ID by decrypting the second DCR based on the second key stream; or
the third processing module is configured to obtain the second ID and the RSC by decrypting the second DCR based on the second key stream.

In some embodiments, the third processing module is configured to perform one of:
in response to the second ID obtained by decrypting the second DCR being the same as stored second ID, determining to establish a second direct communication interface PC5 link between the second UE and the relay UE;
in response to the RSC obtained by decrypting the second DCR being the same as a stored RSC, determining to establish the second PC5 link;
in response to the second ID and the RSC obtained by decrypting the second DCR being the same as the stored second ID and the stored RSC, respectively, determining to establish the second PC5 link;
in response to the second ID obtained by decrypting the second DCR being different from the stored second ID, determining to abort a second PC5 link establishment procedure;
in response to the RSC obtained by decrypting the second DCR being different from the stored RSC, determining to abort the second PC5 link;
in response to the second ID and the RSC obtained by decrypting the second DCR being different from the stored second ID and the stored RSC, determining to abort the second PC5 link.

In some embodiments, the second DCR includes a layer 2 ID;
the third processing module is configured to, in response to the layer 2 ID in the second DCR being the same as a stored layer 2 ID, determine the RSC corresponding to the layer 2 ID based on the layer 2 ID;
the third processing module is further configured to determine the second key stream corresponding to the RSC based on the RSC.

According to a seventh aspect of the embodiments of the present disclosure, there is provided an information processing system, including a first UE, a relay UE and a second UE, where
the first UE is configured to send a first DCR to the relay UE, where the first DCR include first privacy information; the first privacy information includes first ID encrypted based on a first key stream;
the relay UE is configured to send a second DCR to the second UE in response to the first ID obtained by decrypting being the same as stored first ID, where the second DCR includes second privacy information; the second privacy information includes second ID encrypted based on a second key stream.

According to an eighth aspect of the embodiments of the present disclosure, there is provided a communication device, including a processor, a transceiver, a memory and an executable program stored on the memory and can be executed by the processor; where the processor is configured to implement the information processing method according to the first aspect or the second aspect or the third aspect when running the executable instructions.

According to a ninth aspect of the embodiments of the present disclosure, there is provided a computer storage medium, where the computer storage medium stores a computer executable program, and when the executable program is executed by a processor, the information processing method according to the first aspect, or the second aspect, or the third aspect is implemented.

It should be understood that, in the technical solution provided by the embodiments of the present disclosure, the above general description and the detailed description below are only exemplary and explanatory, and cannot limit the embodiment of the present disclosure.

### BRIEF DESCRIPTION OF THE DRAWINGS

The accompanying drawings herein are incorporated into the description and constitute a part of the description, showing one or more embodiments of the present disclosure and used together with the description to explain the principle of the embodiments of the present disclosure.

FIG. 1 is a structural diagram of a wireless communication system according to an example embodiment;

FIG. 2 is a flow diagram of an information processing method according to an example embodiment.

FIG. 3 is a flow diagram of an information processing method according to an example embodiment.

FIG. 4 is a flow diagram of an information processing method according to an example embodiment.

FIG. 5 is a flow diagram of an information processing method according to an example embodiment.

FIG. 6 is a flow diagram of an information processing method according to an example embodiment.

FIG. 7 is a flow diagram of an information processing method according to an example embodiment.

FIG. 8 is a flow diagram of an information processing method according to an example embodiment.

FIG. 9 is a flow diagram of an information processing method according to an example embodiment.

FIG. 10 is a flow diagram of an information processing method according to an example embodiment.

FIG. 11 is a flow diagram of an information processing method according to an example embodiment.

FIG. 12 is a schematic diagram of an encryption and decryption method according to an example embodiment.

FIG. 13 is a flow chart of an information processing method according to an example embodiment.

FIG. 14 is a structural diagram of an information processing device according to an example embodiment.

FIG. 15 is a structural diagram of an information processing device according to an example embodiment.

FIG. 16 is a structural diagram of an information processing device according to an example embodiment.

FIG. 17 is a structural diagram of a UE according to an example embodiment;

FIG. 18 is a structural diagram of a communication device according to an example embodiment.

### DETAILED DESCRIPTION

Here, example embodiments will be described in detail, and examples thereof are shown in the accompanying drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of devices and methods consistent with some aspects of the embodiments of the present disclosure.

The terms used in the embodiments of the present disclosure are only for the purpose of describing specific embodiments and are not intended to limit the embodiments of the present disclosure. The singular forms of “a,” “an,” “said” and “the” used in the present disclosure are also intended to include plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “upon” or “when” or “in response to determining”.

Please refer to FIG. 1, which shows a schematic diagram of a structure of a wireless communication system provided by an embodiment of the present disclosure. As shown in FIG. 1, the wireless communication system is a communication system based on cellular mobile communication technology, and the wireless communication system may include several UEs 11 and several access devices 12.

UE 11 can be a device that provides voice and/or data connectivity to users. UE 11 can communicate with one or more core networks via a radio access network (RAN). UE 11 can be an Internet of Things UE, such as a sensor device, a mobile phone (or called “cellular” phone), and a computer with an Internet of Things UE. For example, it may be a fixed, portable, pocket-sized, handheld, computer-built-in or vehicle-mounted device, such as station (STA), subscriber unit, subscriber station, mobile station, mobile, remote station, access point, remote terminal, access terminal, user terminal, user agent, user device, or user equipment (UE). Alternatively, UE 11 may also be a device of an unmanned aerial vehicle. Alternatively, UE 11 may also be a vehicle-mounted device, for example, a trip computer with a wireless communication function, or a wireless communication device connected externally to the trip computer. Alternatively, UE 11 may also be a roadside device, for example, a street lamp, a signal lamp or other roadside device with a wireless communication function.

The access device 12 may be a network-side device in a wireless communication system. The wireless communication system may be a 4th generation mobile communication technology (4G) system, also known as a long term evolution (LTE) system; or, the wireless communication system may be a 5G system, also known as a new radio (NR) system or a 5G NR system. Alternatively, the wireless communication system may be a next generation system of the 5G system. The access network in the 5G system may be called NG-RAN (New Generation-Radio Access Network). Alternatively, the wireless communication system may be an MTC system.

The access device 12 may be an evolved access device (eNB) used in a 4G system. Alternatively, the access device 12 may also be an access device (gNB) using a central distributed architecture in a 5G system. When the access device 12 uses a central distributed architecture, it generally includes a central unit (CU) and at least two distributed units (DU). The central unit is provided with a protocol stack of a Packet Data Convergence Protocol (PDCP) layer, a Radio Link Control (RLC) layer, and a Media Access Control (MAC) layer. The distributed unit is provided with a Physical (PHY) layer protocol stack. The specific implementation method of the access device 12 is not limited in the embodiments of the present disclosure.

A wireless connection can be established between the access device 12 and the UE 11 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new radio; or, the wireless air interface can also be a wireless air interface based on the next generation mobile communication network technology standard of 5G.

In order to better understand the technical solution described in any embodiment of the present disclosure, first, the relay communication in the related art is partially explained:

In the U2U relay scenario or the UE-to-Network (U2N) relay scenario, based on the security materials provided in the discovery phase, only the relay service code (RSC) and the ProSe Relay user key (PRUK) ID in the DCR message are security protected. In the U2U relay scenario, there is no security method designed for the DCR message. The privacy protection mechanism over U2U relay communication should be studied to support the protection of the user information ID.

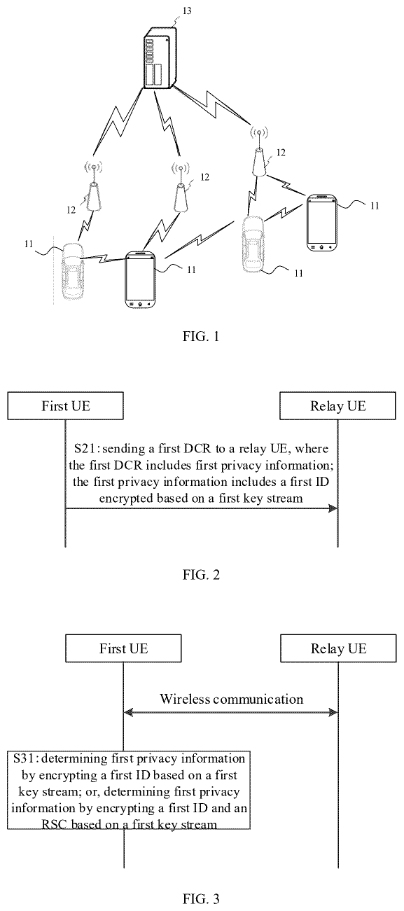

As shown in FIG. 2, the embodiment of the present disclosure provides an information processing method, performed by a first UE, including:

Step S21: sending a first DCR to a relay UE, where the first DCR includes first privacy information; the first privacy information includes a first ID encrypted based on a first key stream.

In the embodiment of the present disclosure, the first UE and the relay UE and the second UE involved below may be, but are not limited to, mobile terminals or fixed terminals. For example, the first UE, the relay UE and the second UE may be, but are not limited to, mobile phones, computers, servers, wearable devices, game control platforms or multimedia devices, etc.

In one embodiment, the first UE may be a source UE and the second UE may be a target UE.

In one embodiment, the relay UE may be a U2U relay UE or a U2N relay UE.

For example, the U2U relay UE may be a relay UE in a U2U relay scenario.

For example, in a U2U relay scenario, the first UE may be a source UE, the relay UE may be a U2U relay UE, and the second UE may be a target UE.

In one embodiment, the first privacy information includes a first ID encrypted based on a first key stream. For example, the first DCR includes the first privacy information, and the first privacy information includes the first ID encrypted based on the first key stream. Thus, in the embodiment of the present disclosure, the first ID may be encrypted.

In another embodiment, the first privacy information includes a first ID encrypted based on a first key stream and an RSC encrypted based on a first key stream. For example, the first DCR includes first privacy information, and the first privacy information includes a first ID encrypted based on a first key stream and an RSC encrypted based on the first key stream. Thus, in the embodiment of the present disclosure, the first ID and the RSC may be encrypted for transmission.

In one embodiment, the RSC may be one or more. In some embodiments of the present disclosure, the multiple may be two or more. Here, the RSC may be configured to indicate a relay service of a proximity-based service (Prose), or a connectivity service of a proximity-based service.

In some embodiments, the first ID includes at least one of the following:
ID of the first UE;
ID of the relay UE;
ID of the second UE;
Key ID of a first link, where the first link is a link between the first UE and the relay UE.

In one embodiment, the first link may be, but is not limited to, a first PC5 link. The first PC5 link is a PC5 link between the first UE and the relay UE.

In one embodiment, the ID of the first UE, the ID of the relay UE, and the ID of the second UE may be, but are not limited to, a Subscription Concealed Identifier (SUCI), a User Info ID, a User Application Layer ID, a Restricted ProSe Application User ID (RPAUID), or a Globally Unique Temporary UE Identity (GUTI). For example, the ID of the first UE may be, but is not limited to, the SUCI, User Info ID, User Application Layer ID, RPAUID, or GUTI, etc. of the first UE. For example, the ID of the relay UE may be, but is not limited to, the SUCI, User Info ID, User Application Layer ID, RPAUID, or GUTI, etc. of the relay UE. For example, the second UE may be, but is not limited to, the SUCI, User Info ID, User Application Layer ID, RPAUID, or GUTI, etc. of the second UE.

In another embodiment, the ID of the first UE may be, but is not limited to, any number or index, etc. configured to indicate the first UE; and/or the ID of the relay UE may be, but is not limited to, any number or index, etc. configured to indicate the relay UE; and/or the ID of the second UE may be, but is not limited to, any number or index, etc. of the second UE; it is sufficient that the ID of the first UE can be configured to identify the first UE, and/or the ID of the relay UE can be configured to identify the relay UE, and/or the ID of the second UE can be configured to identify the second UE.

In one embodiment, the key ID of the first link may be a new radio direct communication interface key (Key New Radio PC5, KNRP) ID. The key ID of the first link may be configured to indicate the KNRP between the first UE and the relay UE. The key ID of the first link can be determined based on historical information. For example, the historical information can be the key ID determined when the first UE and the relay UE establish a PC5 link in the last direct communication between the first UE and the relay UE.

For example, the first ID includes the ID of the first UE, the ID of the relay UE, and the ID of the second UE. The first UE sends a first DCR to the relay UE, and the first DCR includes first privacy information. The first privacy information is the ID of the first UE, the ID of the relay UE, and the ID of the second UE encrypted based on the first key stream, or the first privacy information is the ID of the first UE, the ID of the relay UE, the ID of the second UE, and the RSC encrypted based on the first key stream. In this way, in the embodiment of the present disclosure, the ID of the first UE, the ID of the relay UE, and the ID of the second UE, or the ID of the first UE, the ID of the relay UE, the ID of the second UE, and the RSC can be encrypted once to generate the first privacy information.

For example, the first ID includes the ID of the first UE, the ID of the relay UE, the ID of the second UE, and the key ID of the first link. The first UE sends a first DCR to the relay UE, and the first DCR includes first privacy information. The first privacy information is the ID of the first UE, the ID of the relay UE, the ID of the second UE, and the key ID of the first link encrypted based on the first key stream, or the first privacy information is the ID of the first UE, the ID of the relay UE, the ID of the second UE, the key ID of the first link, and the RSC encrypted based on the first key stream. In this way, in the embodiment of the present disclosure, the ID of the first UE, the ID of the relay UE, the ID of the second UE, and the key ID of the first link, or the ID of the first UE, the ID of the relay UE, the ID of the second UE, the key ID of the first link, and the RSC can be encrypted once to generate the first privacy information.

In some embodiments, the first key stream is determined based on the first key and at least one of the following:
a UTC-based counter;
a bearer;
direction information;
length information.

In one embodiment, the UTC-based counter is a count value, which is increased by one each time encryption/decryption is performed; and/or, the bearer is configured to indicate the bearer ID; and/or, the direction information is configured to indicate whether the first key stream is uplink data or downlink data; and/or, the length information is configured to determine the block length of the first key stream.

In one embodiment, the first key is determined based on at least one of the following:
encryption key (DUCK), where DUCK is configured to encrypt and decrypt the first ID;
scrambling key (DUSK), where DUSK is configured to scramble the first ID;
long-term credential, where the long-term credential is the root key for establishing a PC5 link.

For example, the first key may be KDCR; the KDCR is the key for encrypting information in the DCR.

For example, the encryption key may be configured to encrypt the first ID to obtain the first private information; or, the encryption key may be configured to decrypt the first private information. Here, the encryption key may be configured to decrypt the first private information, that is, it may be configured to decrypt the encrypted first ID.

For example, the long-term credential may be the root key for establishing the first PC5 link, or, the long-term credential may be the root key for establishing the second PC5 link.

Thus, in the embodiment of the present disclosure, the first key for encrypting the DCR information can be determined based on the encryption key, the scrambling key and/or the long-term credential; and the first key stream for encrypting and decrypting the first ID can be determined based on the first key, the UTC-based counter, the bearer, the direction information and the length information.

In one embodiment, the first privacy information is used by the relay UE to determine whether to establish a first PC5 link with the first UE. For example, the relay UE receives the first DCR, and the relay UE decrypts the first privacy information in the first DCR based on the first key stream. If the first ID obtained by decryption is the same as the first ID stored in the relay UE, it is determined to establish the first PC5 link between the relay UE and the first UE; or, if the first ID obtained by decryption is different from the first ID stored in the relay UE, it is determined not to establish the first PC5 link between the relay UE and the first UE.

In one embodiment, the first PC5 link and the second PC5 link involved below can be interfaces between UEs supporting proximity-based service.

In the embodiment of the present disclosure, a first DCR may be sent to the relay UE through the first UE, where the first DCR includes first privacy information, and the first privacy information includes a first ID encrypted based on a first key stream. In this way, a privacy protection mechanism may be provided in the communication from the first UE to the relay UE, and the protection of the first ID (such as a user ID, etc.) may be supported, thereby improving the security of direct communication between the first UE and the relay UE.

In addition, if the first ID includes the ID of the first UE, the ID of the relay UE, and the ID of the second UE, the ID encryption of the first UE (i.e., the source UE), the relay UE, and the second UE (i.e., the target UE) may also be implemented, thereby reducing the leakage of the privacy information of the UE in the U2U relay scenario or the U2N relay scenario, and improving the security of communication in the U2U relay scenario or the U2N relay scenario.

It should be noted that those skilled in the art may understand that the method provided in the embodiments of the present disclosure may be performed alone or together with some methods in the embodiments of the present disclosure or some methods in related art.

As shown in FIG. 3, the embodiment of the present disclosure provides an information processing method, performed by the first UE, including:

Step S31: determining first privacy information by encrypting a first ID based on a first key stream; or, determining first privacy information by encrypting a first ID and an RSC based on a first key stream.

In some embodiments of the present disclosure, the first key stream and the first ID may be the first key stream and the first ID in the above embodiment, respectively. The first privacy information may be the first privacy information in the above embodiment. The RSC may be the RSC in the above embodiment.

In one embodiment, in step S31, determining the first privacy information by encrypting the first ID based on the first key stream includes determining the first privacy information by encrypting the first ID based on the first key stream and the first algorithm identifier.

In one embodiment, the first algorithm identifier is configured to indicate the algorithm for encrypting and decrypting the first ID.

In some embodiments of the present disclosure, the algorithm indicated by the first algorithm identifier and the algorithm indicated by a second algorithm identifier involved below may be, but not limited to, the encryption algorithm (NEA algorithm) specified by the 5G system and/or the algorithm that can support encryption for plaintext with extensible length, etc.

In one embodiment, in step S31, determining the first privacy information by encrypting the first ID and the RSC based on the first key stream includes determining the first privacy information by encrypting the first ID and the RSC based on the first key stream and the first algorithm identifier.

The embodiment of the present disclosure provides an information processing method, performed by the first UE, including: determining the first privacy information by encrypting the first ID based on the first key stream and the first algorithm identifier; or determining the first privacy information by encrypting the first ID and the RSC based on the first key stream and the first algorithm identifier.

In the embodiment of the present disclosure, the first UE may obtain the first privacy information by encrypting the first ID based on the first key stream and the first algorithm identifier, or the first UE may obtain the first privacy information by encrypting the first ID and the RSC based on the first key stream and the first algorithm identifier, so as to implement the security protection mechanism of the communication between the first UE and the relay UE.

It should be noted that those skilled in the art can understand that the method provided in the embodiments of the present disclosure can be performed alone or together with some methods in the embodiments of the present disclosure or some methods in related art.

The following information processing method is performed by the relay UE, which is similar to the description of the information processing method performed by the first UE above; and for the technical details not disclosed in the information processing method embodiment performed by the relay UE, please refer to the description of the information processing method example performed by the first UE, and no detailed description is given here.

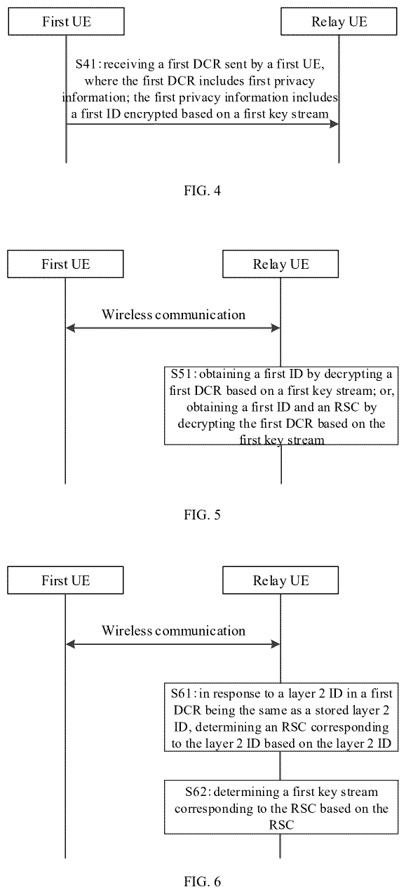

As shown in FIG. 4, the embodiment of the present disclosure provides an information processing method, performed by the relay UE, including:

Step S41: receiving a first DCR sent by a first UE, where the first DCR includes first privacy information; the first privacy information includes a first ID encrypted based on a first key stream.

In some embodiments of the present disclosure, the first UE, the relay UE and the second UE may be the first UE, the relay UE and the second UE in the above embodiment, respectively. For example, the first UE may be the source UE, and the second UE may be the target UE. For example, the relay UE may be a U2U relay UE or a U2N relay UE.

In some embodiments of the present disclosure, the first DCR may be the first DCR in the above embodiment; the first privacy information may be the first privacy information in the above embodiment; the first key stream and the first ID may be the first key stream and the first ID in the above embodiment, respectively.

In one embodiment, the first privacy information includes a first ID encrypted based on a first key stream. For example, the first DCR includes the first privacy information and the RSC, and the first privacy information includes the first ID encrypted based on the first key stream.

In one embodiment, the first privacy information includes a first ID encrypted based on the first key stream and a relay service code encrypted based on the first key stream. For example, the first DCR includes the first privacy information, and the first privacy information includes the first ID encrypted based on the first key stream and the RSC encrypted based on the first key stream.

In one embodiment, the first key stream is determined based on the first key and at least one of the following: a UTC-based counter, a bearer, direction information, and a length information.

In one embodiment, the first key is determined based on at least one of the following:
DUCK, where DUCK is configured to encrypt and decrypt the first ID;
DUSK, where DUSK is configured to scramble the first ID;
long-term credentials, where the long-term credentials are the root key for establishing a PC5 link.

For example, the first key can be KDCR. The KDCR is the key configured to encrypt information in the DCR.

For example, the encryption key can be configured to encrypt the first ID to obtain the first private information; or, the encryption key can be configured to decrypt the first private information. Here, the encryption key can be configured to decrypt the first private information, that is, it can be configured to decrypt the encrypted first ID.

For example, the long-term credential can be a root key for establishing a first PC5 link, or the long-term credential can be a root key for establishing a second PC5 link.

In one embodiment, the first ID includes at least one of the following: the ID of the first UE, the ID of the relay UE, the ID of the second UE, and the key ID of the first link.

For example, the first ID includes the ID of the first UE, the ID of the relay UE, and the ID of the second UE.

For example, the first ID includes the ID of the first UE, the ID of the relay UE, the ID of the second UE, and the key ID of the first link.

In some embodiments of the present disclosure, the ID of the first UE, the ID of the relay UE, the ID of the second UE, and the key ID of the first link can be the ID of the first UE, the ID of the relay UE, the ID of the second UE, and the key ID of the first link in the above-mentioned embodiments, respectively.

For example, the ID of the first UE may be, but is not limited to, the SUCI, User Info ID, User Application Layer ID, RPAUID, GUTI of the first UE, or the number or index of the first UE, etc. The ID of the relay UE may be, but is not limited to, the SUCI, User Info ID, User Application Layer ID, RPAUID, GUTI of the relay UE, or the number or index of the relay UE, etc. The second UE may be, but is not limited to, the SUCI, User Info ID, User Application Layer ID, RPAUID, GUTI of the second UE, or the number or index of the second UE, etc.

In the embodiment of the present disclosure, the first DCR sent by the first UE may be received by the relay UE, where the first DCR includes the first privacy information; the first privacy information includes the first ID encrypted based on the first key stream. In this way, a privacy protection mechanism may be provided in the communication from the first UE to the relay UE, and the protection of the first ID (such as the user ID, etc.) may be supported, thereby improving the security of the direct communication between the first UE and the relay UE.

For the above implementation, please refer to the description on the first UE side, which will not be repeated here.

It should be noted that those skilled in the art can understand that the method provided in the embodiments of the present disclosure can be performed alone or together with some methods in the embodiments of the present disclosure or some methods in related art.

As shown in FIG. 5, the embodiment of the present disclosure provides an information processing method, performed by the relay UE, including:

Step S51: obtaining a first ID by decrypting a first DCR based on a first key stream; or, obtaining a first ID and an RSC by decrypting the first DCR based on the first key stream.

In some embodiments of the present disclosure, the first key stream and the first DCR can be the first key stream and the first DCR in the above embodiment, respectively; the first ID and the RSC can be the first ID and the RSC in the above embodiment, respectively.

In one embodiment, decrypting the first DCR based on the first key stream can be decrypting the first privacy information in the first DCR based on the first key stream.

In one embodiment, in step S51, obtaining the first ID by decrypting the first DCR based on the first key stream includes obtaining the first ID by decrypting the first DCR based on the first key stream and the first algorithm identifier.

In one embodiment, in step S51, obtaining the first ID the RSC by decrypting the first DCR based on the first key stream includes obtaining the first ID the RSC by decrypting the first DCR based on the first key stream and the first algorithm identifier.

In one embodiment, decrypting the first DCR based on the first key stream and the first algorithm identifier may be decrypting the first privacy information in the first DCR based on the first key stream and the first algorithm identifier.

In some embodiments of the present disclosure, the first privacy information may be the first privacy information in the above embodiment; the first algorithm identifier may be the first algorithm identifier in the above embodiment.

In the embodiment of the present disclosure, the relay UE may decrypt the first privacy information in the first DCR based on the first key stream and the first key algorithm to obtain an accurate first ID, or to obtain an accurate first ID and RSC.

It should be noted that those skilled in the art may understand that the method provided in the embodiments of the present disclosure may be performed alone or together with some methods in the embodiments of the present disclosure or some methods in related art.

The embodiment provides an information processing method, performed by a relay UE, including:
determining whether to establish a first PC5 link between the relay UE and a first UE based on a first ID obtained by decrypting a first DCR and a stored first ID; and/or, determining whether to establish a first PC5 link between the relay UE and a first UE based on an RSC obtained by decrypting a first DCR and a stored RSC.

In one embodiment, after the discovery phase ends, the first ID and the RSC may be stored in the relay UE.

The embodiment of the present disclosure provides an information processing method, performed by a relay UE and including one of the following:
in response to a first ID obtained by decrypting a first DCR being the same as a stored first ID, determining to establish a first PC5 link between the relay UE and a first UE;
in response to an RSC obtained by decrypting the first DCR being the same as a stored RSC, determining to establish the first PC5 link;
in response to the first ID and the RSC obtained by decrypting the first DCR being the same as the stored first ID and RSC, respectively, determining to establish the first PC5 link;
in response to the first ID obtained by decrypting the first DCR being different from the stored first ID, determining to terminate the establishment of the first PC5 link;
in response to the RSC obtained by decrypting the first DCR being different from the stored RSC, determining to terminate the establishment of the first PC5 link;
in response to the first ID and the RSC obtained by decrypting the first DCR being different from the stored first ID and RSC, determining to terminate the establishment of the first PC5 link.

In one embodiment, decrypting the first DCR may be decrypting the first privacy information in the first DCR.

In one embodiment, determining to terminate the establishment of the first PC5 link may be determining not to establish the first PC5 link, or determining to terminate the first PC5 link being established.

In one embodiment, the first PC5 link between the first UE and the relay UE may be a one-hop PC5 link in the U2U relay scenario. The second PC5 link between the relay UE and the second UE involved below may be another hop PC5 link in the U2U relay scenario.

In the embodiment of the present disclosure, the first privacy information in the first DCR may be decrypted to obtain the first ID and/or RSC; and by comparing whether the first ID obtained by decryption is the same as the first ID stored in the relay UE, and/or comparing whether the RSC obtained by decryption is the same as the RSC stored in the relay UE, it is determined whether to establish the first PC5 link between the first UE and the relay UE. If they are the same, the first PC5 link is established, or if they are different, the first PC5 link is terminated, so that the first PC5 link between the first UE and the relay UE can be established without damaging the privacy between the first UE and the relay UE.

It should be noted that those skilled in the art can understand that the method provided in the embodiments of the present disclosure may be performed alone or together with some methods in the embodiments of the present disclosure or some methods in related art.

In some embodiments, the first DCR includes a layer 2 (Layer-2, L2) ID; the method includes:
in response to the layer 2 ID in the first DCR being the same as the stored layer 2 ID, determining the RSC corresponding to the layer 2 ID based on the layer 2 ID;
determining the first key stream corresponding to the RSC based on the RSC.

As shown in FIG. 6, the embodiment of the present disclosure provides an information processing method, performed by a relay UE, including:

Step S61: in response to a layer 2 ID in a first DCR being the same as a stored layer 2 ID, determining an RSC corresponding to the layer 2 ID based on the layer 2 ID;

Step S62: determining a first key stream corresponding to the RSC based on the RSC.

In some embodiments of the present disclosure, the first key stream and the RSC may be the first key stream and the RSC in the above-mentioned embodiments, respectively.

In one embodiment, the layer 2 ID may be a source layer 2 ID. Here, the layer 2 ID may be a layer 2 address of the first UE. Of course, the layer 2 ID may also be replaced by other address information of the first UE.

In another embodiment, the layer 2 ID may be a target layer 2 ID. Here, the layer 2 ID may be the layer 2 address of the relay UE, and the layer 2 ID may also be replaced by other address information of the relay UE.

In one embodiment, step S61 includes determining the RSC corresponding to the layer 2 ID based on the layer 2 ID and first mapping information; where the first mapping information is configured to indicate the correspondence between the layer 2 ID and the RSC.

Step S62 includes determining the first key stream corresponding to the RSC based on the RSC and second mapping information; where the second mapping information is configured to indicate the correspondence between the RSC and the first key stream.

The embodiment of the present disclosure provides an information processing method, performed by a relay UE, including:
determining an RSC corresponding to a layer 2 ID based on the layer 2 ID and first mapping information; where the first mapping information is configured to indicate the correspondence between the layer 2 ID and the RSC;
determining a first key stream corresponding to the RSC based on the RSC and second mapping information; where the second mapping information is configured to indicate the correspondence between the RSC and the first key stream.

In one embodiment, determining the first key stream corresponding to the RSC based on the RSC and the second mapping information may be:
determining a first key corresponding to the RSC based on the RSC and the second mapping information; where the second mapping information is configured to indicate the correspondence between the RSC and the first key;
determining the first key stream based on the first key.

In one embodiment, the first mapping information and/or the second mapping information may be pre-stored in the relay UE.

In the embodiment of the present disclosure, the relay UE may determine the RSC based on the layer 2 ID in the first DCR, and determine the first key stream for decrypting the first DCR based on the RSC; thereby facilitating the decryption of the first privacy information included in the first DCR.

It should be noted that those skilled in the art may understand that the method provided in the embodiments of the present disclosure may be performed alone or together with some methods in the embodiments of the present disclosure or some methods in related art.

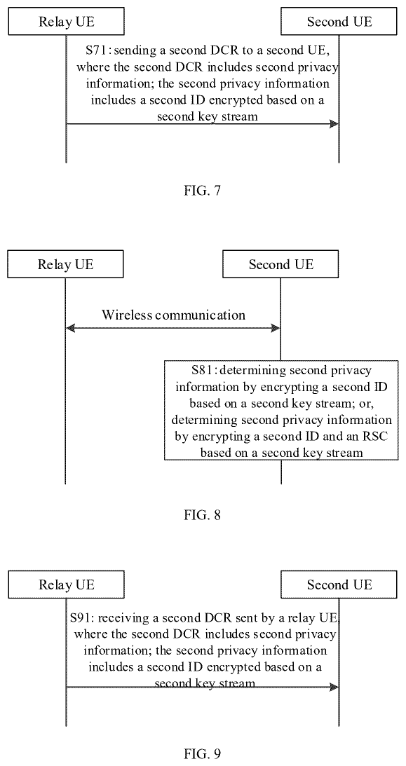

As shown in FIG. 7, the embodiment of the present disclosure provides an information processing method, performed by a relay UE, including:

Step S71: sending a second DCR to a second UE, where the second DCR includes second privacy information; the second privacy information includes a second ID encrypted based on a second key stream.

In one embodiment, the second DCR is the same as the first DCR.

In another embodiment, the second DCR is different from the first DCR.

In one embodiment, the second privacy information is the same as the first privacy information.

In another embodiment, the second privacy information is different from the first privacy information.

In one embodiment, the second ID is the same as the first ID; and/or, the second key stream is the same as the first key stream.

In another embodiment, the second ID is different from the first ID; and/or, the second key stream is different from the first key stream.

In one embodiment, the second privacy information includes a second ID encrypted based on a second key stream. For example, the second DCR includes the second privacy information and the RSC, and the second privacy information includes the second ID encrypted based on the second key stream. In this way, in the embodiments of the present disclosure, the second ID can be encrypted and the RSC can be transmitted without encryption.

In another embodiment, the second privacy information includes a second ID encrypted based on a second key stream and an RSC encrypted based on the second key stream. For example, the second DCR includes the second privacy information, and the second privacy information includes the second ID encrypted based on the second key stream and the RSC encrypted based on the second key stream. In this way, in the embodiment of the present disclosure, the second ID and the RSC can be encrypted for transmission.

In one embodiment, the RSC included in the second DCR or the RSC included in the second privacy information can be one or more.

In some embodiments, the second ID includes at least one of the following: the ID of the first UE, the ID of the relay UE, the ID of the second UE, and the key ID of the second link.

In one embodiment, the second link can be, but is not limited to, a second PC5 link. The second PC5 link is a PC5 link between the relay UE and the second UE.

For example, the second ID includes the ID of the first UE, the ID of the relay UE, and the ID of the second UE. The relay UE sends a second DCR to the second UE, and the second DCR includes the second privacy information. The second privacy information is the ID of the first UE, the ID of the relay UE, and the ID of the second UE encrypted based on the second key stream, or the second privacy information is the ID of the first UE, the ID of the relay UE, the ID of the second UE, and the RSC encrypted based on the second key stream. In this way, in the embodiment of the present disclosure, the ID of the first UE, the ID of the relay UE, and the ID of the second UE, or the ID of the first UE, the ID of the relay UE, the ID of the second UE, and the RSC can be encrypted once to generate the second privacy information.

For example, the second ID includes the ID of the first UE, the ID of the relay UE, the ID of the second UE, and the key ID of the second link. The relay UE sends a second DCR to the second UE, and the second DCR includes the second privacy information. The second privacy information is the ID of the first UE, the ID of the relay UE, the ID of the second UE, and the key ID of the second link encrypted based on the first key stream, or the second privacy information is the ID of the first UE, the ID of the relay UE, the ID of the second UE, the key ID of the second link, and the RSC encrypted based on the first key stream. Thus, in the embodiment of the present disclosure, the ID of the first UE, the ID of the relay UE, the ID of the second UE, and the key ID of the second link, or the ID of the first UE, the ID of the relay UE, the ID of the second UE, the key ID of the second link, and the RSC may be encrypted once to generate the second privacy information.

In some embodiments of the present disclosure, the RSC may be the RSC in the above embodiment; the ID of the first UE, the ID of the relay UE, and the ID of the second UE may be the ID of the first UE, the ID of the relay UE, and the ID of the second UE in the above embodiment, respectively.

In one embodiment, the key ID of the second link may be new radio sidelink communication interface key (Key New Radio PC5, KNRP) ID. The key ID of the second link may be configured to indicate the KNRP between the relay UE and the second UE. The key ID of the second link may be determined based on historical information. For example, the historical information may be the key ID determined when the first UE and the relay UE established the PC5 link in the last direct communication between the relay UE and the second UE.

In some embodiments, the second key stream is determined based on the second key and at least one of the following: a UTC-based counter; a bearer; direction information; and length information.

In some embodiments, the second key stream is determined based on at least one of the following:
DUCK, where DUCK is configured to encrypt and decrypt the second ID;
DUSK, where DUSK is configured to scramble the second ID;
long-term credential, where the long-term credential is the root key for establishing a PC5 link.

In one embodiment, the second key is the same as the first key.

In another embodiment, the second key is different from the first key.

In some embodiments of the present disclosure, the UTC-based counter, the bearer, the direction information and the length information can be the UTC-based counter, the bearer, the direction information and the length information in the above embodiment respectively; DUCK, DUSK and long-term credential can be DUCK, DUSK and long-term credential in the above embodiment respectively.

In an embodiment of the present disclosure, a second DCR can be sent to a second UE through a relay UE, where the second DCR includes second privacy information. The second privacy information includes a second ID encrypted using the second key stream. In this way, a privacy protection mechanism can be implemented in the communication between the relay UE and the second UE, and the protection of the second ID (such as a user ID) can be supported, thereby enhancing the security of direct communication between the relay UE and the second UE.

Furthermore, if the second ID includes the ID of the first UE, the ID of the relay UE, and the ID of the second UE, the IDs of the first UE (i.e., the source UE), the relay UE, and the second UE (i.e., the target UE) can also be encrypted, thereby reducing the leakage of the privacy information of the UE in the U2U relay scenario or the U2N relay scenario, and improving the security of communication in the U2U relay scenario or the U2N relay scenario.

In one embodiment, the second privacy information is used by the second UE to determine whether to establish a second PC5 link with the relay UE. For example, the second UE receives the second DCR, and the second UE decrypts the second privacy information in the second DCR based on the second key stream. If the second ID obtained by decryption is the same as the second ID stored in the second UE, it is determined to establish a second PC5 link between the second UE and the relay UE; or, if the second ID obtained by decryption is different from the second ID stored in the second UE, it is determined not to establish a second PC5 link between the second UE and the relay UE.

In one embodiment, the first privacy information is used by the relay UE to determine whether to send the second DCR.

In some embodiments, in step S71, sending the second DCR to the second UE includes sending the second DCR to the second UE in response to the first ID obtained by decrypting the first DCR being the same as the stored first ID, and/or in response to the RSC obtained by decrypting the first DCR being the same as the stored RSC.

The embodiment of the present disclosure provides an information processing method, performed by a relay UE, and including: sending a second DCR to the second UE in response to the first ID obtained by decrypting the first DCR being the same as the stored first ID, and/or in response to the RSC obtained by decrypting the first DCR being the same as the stored RSC.

In some embodiments, in step S71, sending the second DCR to the second UE includes: sending the second DCR to the second UE after the establishment of a first PC5 link between the first UE and the relay UE.

The embodiment of the present disclosure provides an information processing method, performed by a relay UE, and including: sending a second DCR to a second UE after the establishment of a first PC5 link between a first UE and the relay UE.

The above implementation can be specifically referred to the description on the first UE side, which will not be repeated here.

It should be noted that those skilled in the art can understand that the method provided in the embodiment of the present disclosure can be performed alone or together with some methods in the embodiments of the present disclosure or some methods in related art.

As shown in FIG. 8, the embodiment of the present disclosure provides an information processing method, performed by a relay UE, including:

Step S81: determining second privacy information by encrypting a second ID based on a second key stream; or, determining second privacy information by encrypting a second ID and an RSC based on a second key stream.

In some embodiments of the present disclosure, the second key stream and the second ID can be the second key stream and the second ID in the above embodiment, respectively; the second privacy information can be the second privacy information in the above embodiment; and the RSC can be the RSC in the above embodiment.

In one embodiment, in step S81, determining the second privacy information by encrypting the second ID based on the second key stream includes determining the second privacy information by encrypting the second ID based on the second key stream and the second algorithm identifier.

In one embodiment, the second algorithm identifier is configured to indicate the algorithm for encrypting and decrypting the second ID.

In one embodiment, the algorithm indicated by the second algorithm identifier can be, but is not limited to, the encryption algorithm specified by the 5G system and/or the algorithm that can support the encryption for the plaintext with an extendable length, etc.

In one embodiment, in step S81, determining the second privacy information by encrypting the second ID and the RSC based on the second key stream includes determining the second privacy information by encrypting the second ID and the RSC based on the second key stream and the second algorithm identifier.

The embodiment of the present disclosure provides an information processing method, performed by a relay UE, including: determining second privacy information by encrypting a second ID based on a second key stream and a second algorithm identifier; or determining second privacy information by encrypting a second ID and an RSC based on a second key stream and a second algorithm identifier.

In the embodiment of the present disclosure, the relay UE may obtain the second privacy information by encrypting the second ID based on the second key stream and the second algorithm identifier, or the relay UE may obtain the second privacy information by encrypting the second ID and the RSC based on the second key stream and the second algorithm identifier, so as to implement the security protection mechanism of the communication between the relay UE and the second UE.

The above implementations can be specifically referred to the description on the first UE side, which will not be repeated here.

It should be noted that those skilled in the art can understand that the method provided in the disclosed embodiment can be performed alone or together with some methods in the embodiments of the present disclosure or some methods in related art.

The following information processing method is performed by a second UE, which is similar to the description of the information processing method performed by the first UE and/or the relay UE; and for the technical details not disclosed in the embodiment of the information processing method performed by the second UE, please refer to the description of the example of the information processing method performed by the first UE and/or the relay UE, and no detailed description is given here.

As shown in FIG. 9, the embodiment of the present disclosure provides an information processing method, performed by a second UE, including:

Step S91: receiving a second DCR sent by a relay UE, where the second DCR includes second privacy information; the second privacy information includes a second ID encrypted based on a second key stream.

In some embodiments of the present disclosure, the first UE, the relay UE and the second UE may be the first UE, the relay UE and the second UE in the above embodiment, respectively. For example, the first UE may be the source UE and the second UE may be the target UE. For example, the relay UE may be a U2U relay UE or a U2N relay UE.

In some embodiments of the present disclosure, the second DCR may be the second DCR in the above embodiment; the second privacy information may be the second privacy information in the above embodiment; the second key stream and the second ID may be the second key stream and the second ID in the above embodiment, respectively.

In one embodiment, the second privacy information includes a second ID encrypted based on the second key stream. For example, the second DCR includes the second privacy information and the RSC, and the second privacy information includes the second ID encrypted based on the second key stream. Thus, in the embodiment of the present disclosure, the second ID may be encrypted and the RSC may be transmitted without encryption.

In another embodiment, the second privacy information includes the second ID encrypted based on the second key stream and the RSC encrypted based on the second key stream. For example, the second DCR includes the second privacy information, and the second privacy information includes the second ID encrypted based on the second key stream and the RSC encrypted based on the second key stream. Thus, in the embodiments of the present disclosure, the second ID and the RSC can be encrypted for transmission.

In one embodiment, the RSC included in the second DCR or the RSC included in the second privacy information can be one or more. In some embodiments, the second ID includes at least one of the following: the ID of the first UE, the ID of the relay UE, the ID of the second UE, and the key ID of the second link. For example, the second ID includes the ID of the first UE, the ID of the relay UE, the ID of the second UE. For example, the second ID includes the ID of the first UE, the ID of the relay UE, the ID of the second UE, and the key ID of the second link.

In one embodiment, the key ID of the second link can be the new radio direct communication interface key (Key New Radio PC5, KNRP) ID.

In some embodiments of the present disclosure, the RSC can be the RSC in the above embodiment; the ID of the first UE, the ID of the relay UE, and the ID of the second UE can be the ID of the first UE, the ID of the relay UE, and the ID of the second UE in the above embodiment, respectively.

In some embodiments, the second key stream is determined based on the second key and at least one of the following: the UTC-based counter; the bearer; the direction information; and the length information.

In some embodiments, the second key stream is determined based on at least one of the following:
DUCK, where DUCK is configured to encrypt and decrypt the second ID;
DUSK, where DUSK is configured to scramble the second ID;
long-term credential, where the long-term credential is the root key for establishing a PC5 link.

In some embodiments of the present disclosure, the UTC-based counter, the bearer, the direction information and length information can be the UTC-based counter, the bearer, the direction information and the length information in the above embodiments respectively; DUCK, DUSK and long-term credential can be DUCK, DUSK and long-term credential in the above embodiments respectively.

In an embodiment of the present disclosure, the first UE can receive the second DCR sent by the relay UE, where the second DCR includes the second privacy information, and the second privacy information includes the second ID encrypted based on the second key stream. In this way, a privacy protection mechanism can be provided in the communication from the relay UE to the second UE, and the protection of the second ID (such as the user ID, etc.) can be supported, so as to improve the security of the direct communication between the relay UE and the second UE.

For the above implementation, please refer to the description of the first UE side and/or the relay UE side, which will not be repeated here.

It should be noted that those skilled in the art can understand that the method provided in the embodiment of the present disclosure can be performed alone or together with some methods in the embodiments of the present disclosure or some methods in the related art.

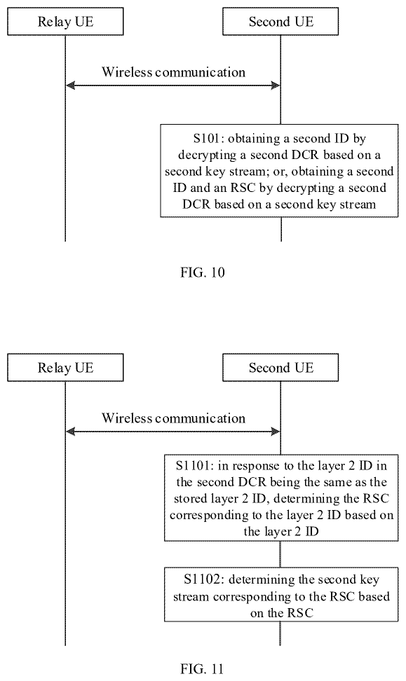

As shown in FIG. 10, the embodiment of the present disclosure provides an information processing method, performed by a second UE, including:

Step S101: obtaining a second ID by decrypting a second DCR based on a second key stream; or, obtaining a second ID and an RSC by decrypting a second DCR based on a second key stream.

In some embodiments of the present disclosure, the second DCR can be the second DCR in the above embodiments; the second privacy information can be the second privacy information in the above embodiments; the second key stream and the second ID can be the second key stream and the second ID in the above embodiments, respectively.

In one embodiment, decrypting the second DCR based on the second key stream can be decrypting the second privacy information in the second DCR based on the second key stream.

In one embodiment, in step S101, obtaining the second ID by decrypting the second DCR based on the second key stream includes obtaining the second ID by decrypting the second DCR based on the second key stream and the second algorithm identifier.

In one embodiment, in step S101, obtaining the second ID and the RSC by decrypting the second DCR based on the second key stream includes obtaining the second ID and the RSC by decrypting the second DCR based on the second key stream and the second algorithm identifier.

In one embodiment, decrypting the second DCR based on the second key stream and the second algorithm identifier may be decrypting the second privacy information in the second DCR based on the second key stream and the second algorithm identifier.

In some embodiments of the present disclosure, the second privacy key may be the second privacy key in the above embodiments; the second algorithm identifier may be the second algorithm identifier in the above embodiments.

In the embodiment of the present disclosure, the second UE may decrypt the second privacy information in the second DCR based on the second key stream and the second key algorithm to obtain an accurate second ID, or to obtain an accurate second ID and RSC.

For the above implementation, please refer to the description of the first UE side and/or the relay UE side, which will not be repeated here.

It should be noted that those skilled in the art can understand that the method provided in the embodiment of the present disclosure may be performed alone or together with some methods in the embodiments of the present disclosure or some methods in related art.

The embodiment of the present disclosure provides an information processing method, performed by a second UE, including:
determining whether to establish a second PC5 link between the second UE and a relay UE based on a second ID obtained by decrypting a second DCR and a stored second ID; and/or, determining whether to establish a second PC5 link between the second UE and a relay UE based on an RSC obtained by decrypting a second DCR and a stored RSC.

In one embodiment, after the discovery phase ends, the second ID and the RSC may be stored in the second UE.

The embodiment of the present disclosure provides an information processing method, performed by a second UE, and including one of the following:
in response to a second ID obtained by decrypting a second DCR being the same as a stored second ID, determining to establish a second direct communication interface PC5 link between the second UE and a relay UE;
in response to an RSC obtained by decrypting the second DCR being the same as a stored RSC, determining to establish a second PC5 link;
in response to the second ID and the RSC obtained by decrypting the second DCR being the same as the stored second ID and RSC, respectively, determining to establish a second PC5 link;
in response to the second ID obtained by decrypting the second DCR being different from the stored second ID, determining to terminate the establishment of the second PC5 link;
in response to the RSC obtained by decrypting the second DCR being different from the stored RSC, determining to terminate the establishment of the second PC5 link;
in response to the second ID and the RSC obtained by decrypting the second DCR being different from the stored second ID and RSC, determining to terminate the second PC5 link.

In one embodiment, decrypting the second DCR may be decrypting the second privacy information in the second DCR.

In one embodiment, determining to terminate the establishment of the second PC5 link may be determining not to establish the second PC5 link, or determining to terminate the second PC5 link being established.

In the embodiment of the present disclosure, the second private information in the second DCR can be decrypted to obtain the second ID and/or RSC; and by comparing whether the second ID obtained by decryption is the same as the second ID stored in the second UE, and/or comparing whether the RSC obtained by decryption is the same as the RSC stored in the second UE, it is determined whether to establish a second PC5 link between the second UE and the relay UE. If they are the same, the second PC5 link is established, or if they are different, the second PC5 link is terminated, so that the second PC5 link between the relay UE and the second UE can be established without damaging the privacy between the relay UE and the second UE.

For the above implementation, please refer to the description of the first UE side and/or the relay UE side, which will not be repeated here.

It should be noted that those skilled in the art can understand that the method provided in the embodiment of the present disclosure can be performed alone or together with some methods in the embodiments of the present disclosure or some methods in related art.

In some embodiments, the second DCR includes a layer 2 ID. The method includes:
in response to the layer 2 ID in the second DCR being the same as the stored layer 2 ID, determining the RSC corresponding to the layer 2 ID based on the layer 2 ID;
determine the second key stream corresponding to the RSC based on the RSC.

As shown in FIG. 11, the embodiment of the present disclosure provides an information processing method, performed by the second UE, including:
Step S1101: in response to the layer 2 ID in the second DCR being the same as the stored layer 2 ID, determining the RSC corresponding to the layer 2 ID based on the layer 2 ID;
Step S1102: determining the second key stream corresponding to the RSC based on the RSC.

In some embodiments of the present disclosure, the first key stream and the RSC may be the first key stream and the RSC in the above embodiments, respectively; the layer 2 ID may be the layer 2 ID in the above embodiments.

For example, the layer 2 ID may be the source layer 2 ID or the target layer 2 ID.

In one embodiment, step S1101 includes determining the RSC corresponding to the layer 2 ID based on the layer 2 ID and third mapping information; where the third mapping information is configured to indicate the correspondence between the layer 2 ID and the RSC.

Step S1102 includes determining the second key stream corresponding to the RSC based on the RSC and fourth mapping information; where the fourth mapping information is configured to indicate the correspondence between the RSC and the second key stream.

The embodiment of the present disclosure provides an information processing method, performed by a second UE, including:
determining an RSC corresponding to a layer 2 ID based on the layer 2 ID and third mapping information; where the third mapping information is used to indicate the correspondence between the layer 2 ID and the RSC;
determining a second key stream corresponding to the RSC based on the RSC and fourth mapping information; wherein the fourth mapping information is configured to indicate the correspondence between the RSC and the second key stream.

In one embodiment, determining the second key stream corresponding to the RSC based on RSC and the fourth mapping information may be:
determining a second key corresponding to RSC based on RSC and the fourth mapping information; where the fourth mapping information is configured to indicate the correspondence between the RSC and the second key;
determining the second key stream based on the second key.

In one embodiment, the third mapping information and/or the fourth mapping information may be pre-stored in the second UE.

In the embodiment of the present disclosure, the second UE may determine the RSC based on the layer 2 ID in the second DCR, and determine the second key stream for decrypting the second DCR based on the RSC; thereby facilitating the decryption of the second privacy information included in the second DCR.

For the above implementation, please refer to the description of the first UE side and/or the relay UE side, which will not be repeated here.

It should be noted that those skilled in the art may understand that the method provided in the embodiment of the present disclosure may be performed alone or together with some methods in the embodiments of the present disclosure or some methods in related art.

The embodiment of the present disclosure provides an information processing system, including a first UE, a relay UE and a second UE; where,
the first UE is configured to send a first DCR to the relay UE, where the first DCR includes first privacy information; the first privacy information includes a first ID encrypted based on a first key stream;
the relay UE is configured to send a second DCR to the second UE in response to a first ID obtained by decrypting the first DCR being the same as a stored first ID; where the second DCR includes second privacy information; the second privacy information includes a second ID encrypted based on a second key stream.

The embodiment of the present disclosure provides an information processing system, including a first UE, a relay UE and a second UE; where,
the first UE is configured to send a first DCR to the relay UE, where the first DCR includes first privacy information; the first privacy information includes a first ID encrypted based on a first key stream;
the relay UE is configured to send a second DCR to the second UE in response to an RSC obtained based on the first DCR being the same as a stored RSC; where the second DCR includes second privacy information; the second privacy information includes a second ID encrypted based on a second key stream.

The embodiment of the present disclosure provides an information processing system, including a first UE, a relay UE and a second UE; where,
the first UE is configured to send a first DCR to the relay UE, where the first DCR includes first privacy information; the first privacy information includes a first ID encrypted based on a first key stream;
the relay UE is configured to send a second DCR to the second UE in response to the first ID obtained by decrypting the first DCR being the same as the stored first ID, and the RSC obtained by decrypting the first DCR being the same as the stored first ID; where the second DCR includes second privacy information; the second privacy information includes a second ID encrypted based on a second key stream.

In some embodiments of the present disclosure, the first UE, the relay UE and the second UE are respectively configured to perform other operations, which can be specifically referred to the description of the method on the first UE side and/or the relay UE side and/or the second UE side, respectively, and will not be repeated here.

With regard to the system in the above embodiment, the specific manner in which each module or network element performs operations have been described in detail in the embodiments of the method, and will not be described in detail here.

In order to further explain any embodiment of the present disclosure, several specific embodiments are provided below.

### Example 1

In some application scenarios, the 5G proximity service source UE (i.e., the first UE) and the 5G proximity service UE-to-UE relay (i.e., the relay UE) use code-sending security parameters or code-receiving security parameters or code security parameters or long-term credentials for discovery to encrypt the first UE ID, the relay UE ID, the second UE ID and the RSC. For example, the first DCR or the second DCR in the above embodiment is sent. When receiving the first DCR or the second DCR, the relay UE and the second UE use the code-sending security parameters or code-receiving security parameters or code security parameters or long-term credentials for discovery to decrypt the encrypted ID of the first UE, the ID of the relay UE, the ID of the second UE and RSC, and check whether the ID of the first UE, the ID of the relay UE, the ID of the second UE and RSC obtained by decryption match (i.e. are the same as) the ID of the first UE, the ID of the relay UE, the ID of the second UE and RSC sent in the discovery message, respectively. If at least one of the above information does not match, the relay UE or the second UE will terminate the PC5 link (e.g., the first PC5 link or the second PC5 link in the above embodiment) establishment process. Here, the code-sending security parameters or code-receiving security parameters or code security parameters or long-term credentials used for decryption by the relay UE can be the first key stream in the above embodiments; the code-sending security parameters or code-receiving security parameters or code security parameters or long-term credentials used for decryption by the second UE can be the second key stream in the above embodiments.

After discovery and relay UE selection, the relay UE and the second UE can determine the RSC based on the source layer 2 ID or target layer 2 ID in the received first DCR and the second DCR, respectively; and determine the corresponding code-sending security parameters or code-receiving security parameters or code security parameters or long-term credentials based on the RSC. In this way, the source layer 2 ID or target layer 2 ID can be linked with the code-sending security parameters or code-receiving security parameters or code security parameters or long-term credentials.

The first UE and the relay UE can encrypt the ID of the first UE, the ID of the relay UE, the ID of the second UE and the RSC based on the key stream (the first key stream or the second key stream) respectively:

Step 1201: if the first UE and/or the relay UE are configured with an encryption key, a scrambling key and/or a long-term credential, the first key in the first DCR or the second key in the second DCR can be determined based on the encryption key and/or the scrambling key and/or the long-term credential. Alternatively, if the first UE or relay UE is not configured with an encryption key, a scrambling key and/or a long-term credential, the first DCR and/or the second DCR are not protected; in this case, step S1202 or S1203 may be skipped.

Step 1202: the key stream (e.g., the first key stream or the second key stream) used for encryption by the first UE and/or relay UE may be determined based on KDCR (e.g., the first key stream or the second key stream), the UTC-based counter, the bearer, the direction information and/or the length information.

Step 1203: the first UE and/or the relay UE XORs the key stream (e.g., the first key stream or the second key stream) with the ID of the first UE, the ID of the relay UE, the ID of the second UE and the RSC to obtain a private text (e.g., a first private text or a second private text). For example, the first private text=RSC+the ID of the first UE+the ID of the relay UE+the ID of the second UE. For another example, the first privacy text=RSC+ID of the first UE+ID of the relay UE+ID of the second UE+other IDs; the other IDs may be the key ID of the first link, or the privacy identifier of other terminal devices (or UEs). Here, the first UE will encrypt the ID of the first UE, the ID of the relay UE, the ID of the second UE, and other IDs based on the first key stream to obtain the first privacy text.

The relay UE and the second UE may decrypt the encrypted ID of the first UE, the encrypted ID of the relay UE, the encrypted ID of the second UE, and the encrypted RSC based on the key stream (the first key stream or the second key stream), respectively:

Step 1204: if the relay UE and/or the second UE are configured with encryption keys, scrambling keys, and/or long-term credentials, the first key in the first DCR or the second key in the second DCR may be determined based on the encryption keys, scrambling keys, and/or long-term credentials. Alternatively, if the first UE or the relay UE is not configured with encryption keys, scrambling keys, and/or long-term credentials, the first DCR and/or the second DCR are not protected; at this time, step S1205 or S1206 may be skipped.

Step 1205: the key stream (e.g., the first key stream or the second key stream) used for decryption by the relay UE and/or the second UE can be determined based on the KDCR (e.g., the first key stream or the second key), the UTC-based counter, the bearer, the direction information and/or the length information;

Step 1206: the relay UE and/or the second UE decrypts the key stream (e.g., the first key stream or the second key stream) and the encrypted privacy text (e.g., the first privacy text or the second privacy text) to obtain the ID of the first UE, the ID of the relay UE, the ID of the second UE and the RSC.

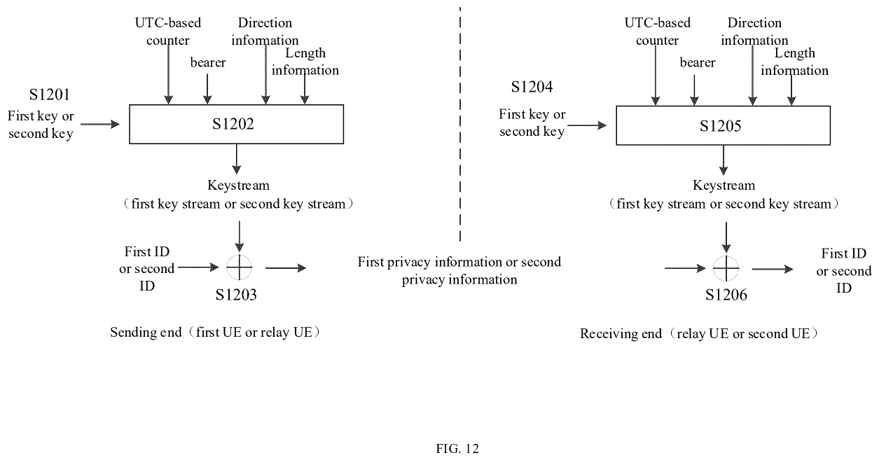

As shown in FIG. 12, the execution of the above steps S1201 to S1203 can refer to the operation of the sending end (the first UE or the relay UE), and the execution of steps S1204 to S1206 can refer to the operation of the receiving end (the relay UE or the second UE). For example, in the above embodiments, the key stream (e.g., the first key stream or the second key stream) can be generated using the selected encryption algorithm of the input parameters in the following Table 1:

TABLE 1
KEY: 128 least significant bits of the output of the KDF (K_{DCR}, UTC-based counter)
or the 128 bit significant bits of the K_{DCR}; //*128 least significant bits of the output of
(KDCR, UTC-based counter) the key derivation function or the 128 significant bits of

| | |
|---|---|
| the KDCR *// | |
| COUNT | : UTC-based counter |
| BEARER | : 0x00 |
| DIRECTION | : 0x00 |
| LENGTH | : the length of ID privacy text |

The output keystream of the ciphering algorithm (output_keystream) is then masked with
the Encrytped_bits_mask to produce the final keystream for the ID privacy
confidentiality protection (KEYSTREAM). //* The output keystream of the ciphering
algorithm (output_keystream) is then masked with Encrytped_bits_mask to produce the
final keystream for ID privacy confidentiality protection (keystream)*//
KEYSTREAM = output_keystream AND (Encrypted_bits_mask || 0xFF..FF) where the
length of Encrypted_bits_mask is set to Min (the length of ID privacy text - 48 , 224).
//* KEYSTREAM = output_keystream_sum AND (Encrypted_bits_mask|| 0xFF..FF),
where the length of Encrypted_bits_mask is set to the minimum value (length of ID
privacy text - 48, 224).*//

Here, the ID privacy text is the first privacy information or the second privacy information in the above embodiments. Here, the NEA algorithm or the like can be used for encryption and decryption. For the above implementation, please refer to the description of the first UE side and/or the relay UE side and/or the second UE side, which will not be repeated here.

It should be noted that those skilled in the art can understand that the method provided in the embodiment of the present disclosure can be performed alone or together with some methods in the embodiments of the present disclosure or some methods in related art.

### Example 2

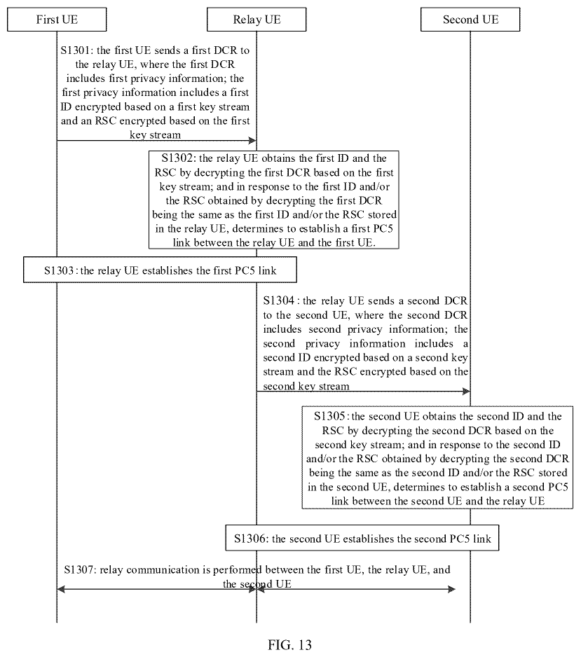

As shown in FIG. 13, the embodiment of the present disclosure provides an information processing method, performed by a communication device, and the communication device including a first UE, a relay UE, and a second UE. The information processing method includes the following steps:

Step S1301: the first UE sends a first DCR to the relay UE, where the first DCR includes first privacy information; the first privacy information includes a first ID encrypted based on a first key stream and an RSC encrypted based on the first key stream.

In some embodiments of the present disclosure, the first DCR may be the first DCR in the above embodiments; the first privacy information, the first key stream, and the first ID may be the first privacy information, the first key stream, and the first ID in the above embodiments, respectively; the RSC may be the RSC in the above embodiment.

For example, the first ID includes the ID of the first UE, the ID of the relay UE, the ID of the second UE, and the key ID of the first link.

For example, the first UE is the source UE; the relay UE is the U2U relay UE; and the second UE is the target UE.

Step S1302: the relay UE obtains the first ID and the RSC by decrypting the first DCR based on the first key stream; and in response to the first ID and/or the RSC obtained by decrypting the first DCR being the same as the first ID and/or the RSC stored in the relay UE, determines to establish a first PC5 link between the relay UE and the first UE.

Step S1303: the relay UE establishes the first PC5 link.

Step S1304: the relay UE sends a second DCR to the second UE, where the second DCR includes second privacy information; the second privacy information includes a second ID encrypted based on a second key stream and the RSC encrypted based on the second key stream;

In some embodiments of the present disclosure, the second DCR may be the second DCR in the above embodiments; the second privacy information, the second key stream, and the second ID may be the second privacy information, the second key stream, and the second ID in the above embodiments; the RSC may be the RSC in the above embodiments.

For example, the second ID includes the ID of the first UE, the ID of the relay UE, the ID of the second UE, and the key ID of the second link.

Step S1305: the second UE obtains the second ID and the RSC by decrypting the second DCR based on the second key stream; and in response to the second ID and/or the RSC obtained by decrypting the second DCR being the same as the second ID and/or the RSC stored in the second UE, determines to establish a second PC5 link between the second UE and the relay UE.

Step S1306: the second UE establishes the second PC5 link.

Step S1307: relay communication is performed between the first UE, the relay UE, and the second UE.

For the above implementations, please refer to the description of the first UE side and/or the relay UE side and/or the second UE side, which will not be repeated here.

It should be noted that those skilled in the art can understand that the method provided in the embodiment of the present disclosure can be performed alone or together with some methods in the embodiments of the present disclosure or some methods in related art.

As shown in FIG. 14, an embodiment of the present disclosure provides an information processing device, including:

a first sending module 41 configured to send a first DCR to a relay UE, where the first DCR includes first privacy information; the first privacy information includes a first ID encrypted based on a first key stream.

The information processing device provided by the embodiment of the present disclosure may be a first UE.

In some embodiments, the first privacy information further includes an RSC encrypted based on a first key stream.

An embodiment of the present disclosure provides an information processing device, including a first sending module 41 configured to send a first DCR to a relay UE, where the first DCR includes first privacy information and an RSC; the first privacy information includes a first ID encrypted based on a first key stream.

An embodiment of the present disclosure provides an information processing device, including a first sending module 41 configured to send a first DCR to a relay UE, where the first DCR includes first privacy information; the first privacy information includes a first ID encrypted based on a first key stream and an RSC encrypted based on a first key stream.

The embodiment of the present disclosure provides an information processing device, including a first sending module 41 configured to send a first DCR to a relay UE, where the first DCR includes first privacy information; the first privacy information includes the ID of the first UE, the ID of the relay UE, and the ID of the second UE encrypted based on the first key stream.

In some embodiments, the first ID includes at least one of the following:
ID of the first UE;
ID of the relay UE;
ID of the second UE;
the key ID of the first link; where the first link is a link between the first UE and the relay UE.

The embodiment of the present disclosure provides an information processing device, including a first processing module, configured to determine first privacy information by encrypting a first ID based on a first key stream.

The embodiment of the present disclosure provides an information processing device, including a first processing module, configured to determine first privacy information by encrypting a first ID and an RSC based on a first key stream.

In some embodiments, the first key stream is determined based on the first key and at least one of the following:
a UTC-based counter;
a bearer;
direction information;
length information.

In some embodiments, the first key is determined based on at least one of the following:
DUCK, where DUCK is configured to encrypt and decrypt the first ID;
DUSK, where DUSK is configured to scramble the first ID;
long-term credential, wherein the long-term credential is the root keys for establishing a direct communication interface (PC5) link.

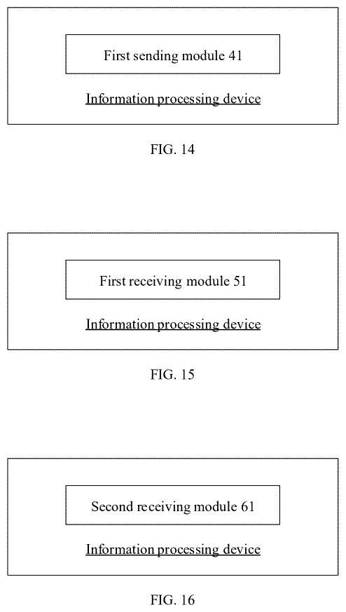

As shown in FIG. 15, an embodiment of the present disclosure provides an information processing device, including:

a first receiving module 51, configured to receive a first DCR sent by a first UE, where the first DCR includes first privacy information; the first privacy information includes a first ID encrypted based on a first key stream.

The information processing device provided by the embodiment of the present disclosure may be a relay UE.

In some embodiments, the first privacy information further includes an RSC encrypted based on the first key stream.

In some embodiments, the first ID includes at least one of the following:
ID of the first UE;
ID of the relay UE;
ID of the second UE;
key ID of the first link, where the first link is a link between the first UE and the relay UE.

An embodiment of the present disclosure provides an information processing device, including a second processing module, configured to obtain a first ID by decrypting a first DCR based on a first key stream.

The embodiment of the present disclosure provides an information processing device, including a second processing module, configured to obtain a first ID and an RSC by decrypting a first DCR based on a first key stream.

The embodiment of the present disclosure provides an information processing device, including a second processing module, where the second processing module is configured to perform one of the following:
in response to a first ID obtained by decrypting a first DCR being the same as a stored first ID, determining to establish a first PC5 link between a relay UE and a first UE;
in response to an RSC obtained by decrypting the first DCR being the same as a stored RSC, determining to establish the first PC5 link;
in response to the first ID and the RSC obtained by decrypting the first DCR being the same as the stored first ID and RSC respectively, determining to establish the first PC5 link;
in response to the first ID obtained by decrypting the first DCR being different from the stored first ID, determining to terminate the establishment of the first PC5 link;
in response to the RSC obtained by decrypting the first DCR being different from the stored RSC, determining to terminate the establishment of the first PC5 link;
in response to the first ID and the RSC obtained by decrypting the first DCR being different from the stored first ID and RSC respectively, determining to terminate the establishment of the first PC5 link.

In some embodiments, the first DCR includes a layer 2 ID.

The second processing module is configured to determine the RSC corresponding to the layer 2 ID based on the layer 2 ID, in response to the layer 2 ID in the first DCR being the same as the stored layer 2 ID.

The second processing module is further configured to determine a first key stream corresponding to the RSC based on the RSC.

The embodiment of the present disclosure provides an information processing device, including a second processing module, configured to determine an RSC corresponding to a layer 2 ID based on the layer 2 ID, in response to the layer 2 ID in the first DCR being the same as the stored layer 2 ID, and determine a first key stream corresponding to the RSC based on the RSC.

The embodiment of the present disclosure provides an information processing device, including a second sending module, configured to send a second DCR to a second UE, where the second DCR includes second privacy information; the second privacy information includes a second ID encrypted based on a second key stream.

In some embodiments, the second privacy information further includes an RSC encrypted based on a second key stream.

The embodiment of the present disclosure provides an information processing device, including a second sending module, configured to send a second DCR to a second UE, where the second DCR includes second privacy information and an RSC; the second privacy information includes a second ID encrypted based on a second key stream.

The embodiment of the present disclosure provides an information processing device, including a second sending module, configured to send a second DCR to a second UE, where the second DCR includes second privacy information; the second privacy information includes a second ID encrypted based on a second key stream and an RSC encrypted based on a second key stream.

The embodiment of the present disclosure provides an information processing device, including a second sending module, configured to send a second DCR to a second UE, where the second DCR includes second privacy information; the second privacy information includes an ID of a first UE, an ID of a relay UE, and an ID of a second UE encrypted based on a second key stream.

In some embodiments, the second ID includes at least one of the following:
ID of the first UE;
ID of the relay UE;
ID of the second UE;
key ID of a second link; where the second link is a link between the relay UE and the second UE.

The embodiment of the present disclosure provides an information processing device, including a second processing module, configured to determine second privacy information by encrypting a second ID based on a second key stream.

The embodiment of the present disclosure provides an information processing device, including a second processing module, configured to determine second privacy information by encrypting a second ID and an RSC based on a second key stream.

In some embodiments, the second key stream is determined based on the second key and at least one of the following:
a UTC-based counter;
a bearer;
direction information;
length information.

In some embodiments, the second key stream is determined based on at least one of the following:
DUCK, where DUCK is configured to encrypt and decrypt the second ID;
DUSK, where DUSK is configured to scramble the second ID;
long-term credential, where the long-term credential is the root key for establishing a PC5 link.

As shown in FIG. 16, the embodiment of the present disclosure provides an information processing device, including:

a second receiving module 61 configured to receive a second DCR sent by a relay UE, where the second DCR includes second privacy information; the second privacy information includes a second ID encrypted based on a second key stream.

The information processing device provided by the embodiment of the present disclosure may be a second UE.

In some embodiments, the second privacy information further includes a relay service code RSC based on the second key stream.

In some embodiments, the second ID includes at least one of the following:
ID of the first UE;
ID of the relay UE;
ID of the second UE;
key ID of a second link; where the second link is a link between the relay UE and the second UE.

The embodiment of the present disclosure provides an information processing device, including a third processing module, configured to obtain a second ID by decrypting a second DCR based on a second key stream.

The embodiment of the present disclosure provides an information processing device, including a third processing module, configured to obtain a second ID and an RSC by decrypting a second DCR based on a second key stream.

The embodiment of the present disclosure provides an information processing device, including a third processing module, where, the third processing module is configured to perform one of the following:
in response to a second ID obtained by decrypting a second DCR being the same as a stored second ID, determining to establish a second direct communication interface PC5 link between a second UE and a relay UE;
in response to an RSC obtained by decrypting the second DCR being the same as a stored RSC, determining to establish a second PC5 link;
in response to the second ID and the RSC obtained by decrypting the second DCR being the same as the stored second ID and RSC, respectively, determining to establish a second PC5 link;
in response to the second ID obtained by decrypting the second DCR being different from the stored second ID, determining to terminate the establishment of the second PC5 link;
in response to the RSC obtained by decrypting the second DCR being different from the stored RSC, determining to terminate the second PC5 link;
in response to the second ID and the RSC obtained by decrypting the second DCR being different from the stored second ID and RSC, respectively, determining to terminate the second PC5 link.

In some embodiments, the second DCR includes a layer 2 ID.

The third processing module is configured to determine the RSC corresponding to the layer 2 ID based on the layer 2 ID, in response to the layer 2 ID in the second DCR being the same as the stored layer 2 ID.

The third processing module is further configured to determine a second key stream corresponding to the RSC based on the RSC.

The embodiment of the present disclosure provides an information processing device, including a third processing module configured to determine an RSC corresponding to a layer 2 ID based on the layer 2 ID, in response to the layer 2 ID in a second DCR being the same as a stored layer 2 ID, and determine a second key stream corresponding to the RSC based on the RSC.

It should be noted that those skilled in the art can understand that the device provided in the embodiment of the present disclosure can be performed alone or together with some devices in the embodiments of the present disclosure or some devices in the related art.

Regarding the device in the above embodiment, the specific manner in which each module performs the operation has been described in detail in the embodiment of the method, and will not be elaborated here.

The embodiment of the present disclosure provides a communication device, including:
a memory for storing processor executable instructions;
a processor, respectively connected to the memory;
where the processor is configured to execute the information processing method provided by any of the aforementioned technical solutions.

The processor may include various types of storage media, which are non-temporary computer storage media, and can continue to memorize the information stored thereon after the communication device loses power.

Here, the communication device includes a first UE, a relay UE, and a second UE.

The processor may be connected to the memory through a bus, etc., for reading an executable program stored on the memory, for example, at least one of the methods shown in FIGS. 2 to 11 and 13.

The embodiment of the present disclosure also provides a computer storage medium, which stores a computer executable program, and when the executable program is executed by the processor, the information processing method of any embodiment of the present disclosure is implemented. For example, at least one of the methods shown in FIGS. 2 to 11 and 13.

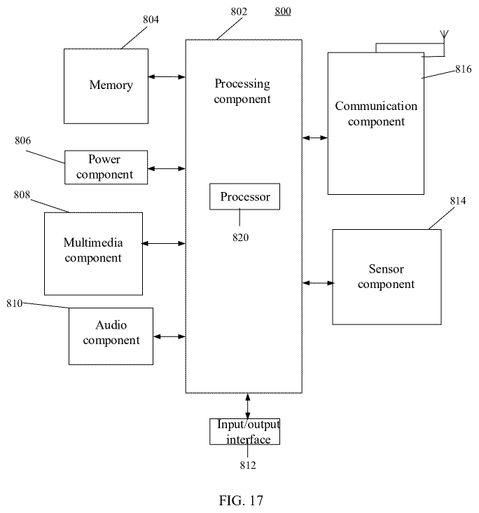

FIG. 17 is a block diagram of a UE 800 shown according to an example embodiment. For example, UE 800 may be a mobile phone, a computer, a digital broadcast user device, a messaging device, a game console, a tablet device, a medical device, a fitness device, a personal digital assistant, etc.

Referring to FIG. 17, UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of UE 800, such as operations associated with display, phone calls, data communications, camera operations, and recording operations. The processing component 802 may include one or more processors 820 to execute instructions to generate all or part of the steps of the above-mentioned method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations in UE 800. Examples of such data include instructions for any application or method operating on UE800, contact data, phonebook data, messages, pictures, videos, etc. Memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of UE 800. The power component 806 may include a power management system, one or more power supplies, and other components associated with generating, managing and distributing power for UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundary of a touch or sliding action, but also detect the duration and pressure associated with the touch or sliding action. In some embodiments, the multimedia component 808 includes a front camera and/or a rear camera. When the UE 800 is in an operating mode, such as a shooting mode or a video mode, the front camera and/or the rear camera may receive external multimedia data. Each front camera and rear camera may be a fixed optical lens system or have focal length and optical zoom capabilities.

The audio component 810 is configured to output and/or input audio signals. For example, the audio component 810 includes a microphone (MIC), and when the UE 800 is in an operating mode, such as a call mode, a recording mode, and a voice recognition mode, the microphone is configured to receive an external audio signal. The received audio signal may be further stored in the memory 804 or sent via the communication component 816. In some embodiments, the audio component 810 also includes a speaker for outputting audio signals.

The I/O interface 812 provides an interface between the processing component 802 and the peripheral interface module, which may be a keyboard, a click wheel, a button, etc. These buttons may include, but are not limited to, a home button, a volume button, a start button, and a lock button.

The sensor component 814 includes one or more sensors for providing various aspects of status assessment for the UE800. For example, the sensor component 814 can detect the open/closed state of the UE 800, the relative positioning of components, such as the display and keypad of the UE 800. The sensor component 814 can also detect the position change of the UE 800 or a component of the UE 800, the presence or absence of user contact with the UE 800, the orientation or acceleration/deceleration of the UE 800, and the temperature change of the UE 800. The sensor component 814 may include a proximity sensor configured to detect the presence of nearby objects without any physical contact. The sensor component 814 may also include an optical sensor, such as a CMOS or CCD image sensor, for use in imaging applications. In some embodiments, the sensor component 814 may also include an accelerometer, a gyroscope sensor, a magnetic sensor, a pressure sensor, or a temperature sensor.

The communication component 816 is configured to facilitate wired or wireless communication between the UE 800 and other devices. UE 800 can access a wireless network based on a communication standard, such as WiFi, 2G or 3G, or a combination thereof. In an example embodiment, the communication component 816 receives a broadcast signal or broadcast-related information from an external broadcast management system via a broadcast channel. In an example embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an example embodiment, UE 800 can be implemented by one or more of an application-specific integrated circuit (ASIC), a digital signal processor (DSP), a digital signal processing device (DSPD), a programmable logic device (PLD), a field programmable gate array (FPGA), a controller, a microcontroller, a microprocessor or other electronic components for performing the above method.

In an example embodiment, a non-temporary computer-readable storage medium including instructions is also provided, such as a memory 804 including instructions, and the above instructions can be executed by a processor 820 of UE800 to generate the above method. For example, the non-transitory computer-readable storage medium may be a ROM, a random access memory (RAM), a CD-ROM, a magnetic tape, a floppy disk, an optical data storage device, and the like.

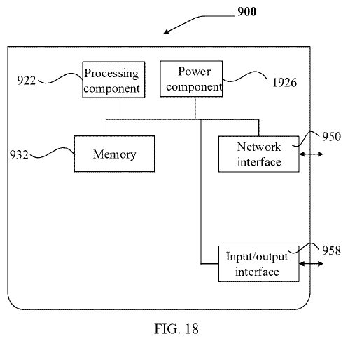

As shown in FIG. 18, an embodiment of the present disclosure shows a structure of an access device. For example, the communication device 900 may be provided as a network side device. The communication device may be various network elements such as the aforementioned access network element and/or network function.

Referring to FIG. 18, the communication device 900 includes a processing component 922, which further includes one or more processors, and a memory resource represented by a memory 932 for storing instructions executable by the processing component 922, such as an application. The application stored in the memory 932 may include one or more modules each corresponding to a set of instructions. In addition, the processing component 922 is configured to execute instructions to execute any method of the aforementioned methods applied to the access device, for example, as shown in any one of FIG. 4 to FIG. 9.

The communication device 900 may further include a power component 926 configured to perform power management of the communication device 900, a wired or wireless network interface 950 configured to connect the communication device 900 to a network, and an input/output (I/O) interface 958. The communication device 900 can operate based on an operating system stored in the memory 932, such as Windows Server™, Mac OS X™, Unix™, Linux™, FreeBSD™ or the like.

In the absence of contradiction, each step in a certain embodiment or example can be implemented as an independent embodiment, and the steps can be arbitrarily combined. For example, a solution after removing some steps in a certain embodiment or example can also be implemented as an independent embodiment, and the order of the steps in a certain embodiment or example can be arbitrarily exchanged. In addition, the optional methods or optional examples in a certain embodiment or example can be arbitrarily combined. In addition, the various embodiments or examples can be arbitrarily combined. For example, some or all steps of different embodiments or examples can be arbitrarily combined, and a certain embodiment or example can be arbitrarily combined with the optional methods or optional examples of other embodiments or examples.

After considering the specification and practicing the present disclosure herein, it will be easy for those skilled in the art to think of other embodiments of the present disclosure. The present disclosure is intended to cover any variants, uses or adaptive changes of the present disclosure, which follow the general principles of the present disclosure and include common knowledge or conventional technical means in the technical field not disclosed in the present disclosure. The description and examples are to be regarded as exemplary only, and the true scope and spirit of the disclosure are indicated by the following claims.

It should be understood that the present disclosure is not limited to the precise structure which has been described above and shown in the drawings, and various modifications and changes may be made without departing from the scope thereof. The scope of the present disclosure is limited only by the appended claims.

1. A method for information processing performed by a first user equipment (UE), the method comprising:
sending a first direct communication request (DCR) to a relay UE, wherein the first DCR comprises first privacy information; the first privacy information comprises first identification information (ID) encrypted based on a first key stream.

2. The method according to claim 1, wherein the first privacy information further comprises a relay service code (RSC) encrypted based on the first key stream.

3. The method according to claim 1, wherein the first ID comprises at least one of:
ID of the first UE;
ID of the relay UE;
ID of a second UE; or
key ID of a first link; wherein the first link is a link between the first UE and the relay UE.

4. The method according to claim 1, further comprising:
determining the first privacy information by encrypting the first ID based on the first key stream; or
determining the first privacy information by encrypting the first ID and the RSC based on the first key stream,
wherein the first key stream is determined based on a first key and at least one of:
a Coordinated Universal Time (UTC)-based counter;
a bearer;
direction information; or
length information.

5. (canceled)

6. The method according to claim 4, wherein the first key is determined based on at least one of:
a discovery user confidentiality key (DUCK), wherein the DUCK is configured to encrypt and decrypt the first ID;
a discovery user scrambling key (DUSK), wherein the DUSK is configured to scramble the first ID; or
a long-term credential, wherein the long-term credential is a root key for establishing a direct communication interface PC5 link.

7. A method for information processing, performed by a relay user equipment (UE), the method comprising:
receiving a first direct communication request (DCR) sent by a first UE, wherein the first DCR comprises first privacy information; the first privacy information comprises first identification information (ID) encrypted based on a first key stream.

8. The method according to claim 7, wherein the first privacy information further comprises a relay service code (RSC) encrypted based on the first key stream.

9. (canceled)

10. The method according to claim 8, further comprising:
obtaining the first ID by decrypting the first DCR based on the first key stream; or
obtaining the first ID and the RSC by decrypting the first DCR based on the first key stream.

11. The method according to claim 10, further comprises one of:
in response to the first ID obtained by decrypting the first DCR being the same as a stored first ID, determining to establish a first direct communication interface PC5 link between the relay UE and the first UE;
in response to the RSC obtained by decrypting the first DCR being the same as a stored RSC, determining to establish the first PC5 link;
in response to the first ID and the RSC obtained by decrypting the first DCR being the same as the stored first ID and the stored RSC, respectively, determining to establish the first PC5 link;
in response to the first ID obtained by decrypting the first DCR being different from the stored first ID, determining to abort a first PC5 link establishment procedure;
in response to the RSC obtained by decrypting the first DCR being different from the stored RSC, determining to abort the first PC5 link establishment procedure; or
in response to the first ID and the RSC obtained by decrypting the first DCR being different from the stored first ID and the stored RSC, respectively, determining to abort the first PC5 link establishment procedure.

12. The method according to claim 10, wherein the first DCR comprises a layer 2 ID; and the method comprises:
in response to the layer 2 ID in the first DCR is the same as a stored layer 2 ID, determining the RSC corresponding to the layer 2 ID based on the layer 2 ID; and
determining the first key stream corresponding to the RSC based on the RSC.

13. The method according to claim 7, further comprising:
sending a second DCR to a second UE, wherein the second DCR comprises second privacy information; the second privacy information comprises second identification information ID encrypted based on a second key stream.

14. The method according to claim 13, wherein the second privacy information further comprises an RSC encrypted based on the second key stream.

15. The method according to claim 13, wherein the second ID comprises at least one of:
ID of the first UE;
ID of the relay UE;
ID of the second UE; or
key ID of a second link; wherein the second link is a link between the relay UE and the second UE.

16. The method according to claim 14, further comprising:
determining the second privacy information by encrypting the second ID based on the second key stream; or
determining the second privacy information by encrypting the second ID and the RSC based on the second key stream.

17. The method according to claim 16, wherein the second key stream is determined based on a second key and at least one of:
a Coordinated Universal Time (UTC)-based counter;
a barrier;
direction information; or
length information,
wherein the second key is determined based on at least one of:
a discovery user confidentiality key (DUCK), wherein the DUCK is configured to encrypt and decrypt the second ID;
a discovery user scrambling key (DUSK), wherein the DUSK is configured to scramble the second ID; or
a long-term credential, wherein the long-term credential is a root key for establishing a PC5 link.

18. (canceled)

19. A method for information processing performed by a second user equipment (UE), the method comprising:
receiving a second direct communication request (DCR) sent by a relay UE, wherein the second DCR comprises second privacy information; the second privacy information comprises second identification information (ID) encrypted based on a second key stream.

20. The method according to claim 19, wherein the second privacy information further comprises a relay service code (RSC) based on the second key stream.

21. (canceled)

22. The method according to claim 20, further comprising:
obtaining the second ID by decrypting the second DCR based on the second key stream; or
obtaining the second ID and the RSC by decrypting the second DCR based on the second key stream.

23. The method according to claim 22, further comprising one of:
in response to the second ID obtained by decrypting the second DCR being the same as stored second ID, determining to establish a second direct communication interface PC5 link between the second UE and the relay UE;
in response to the RSC obtained by decrypting the second DCR being the same as a stored RSC, determining to establish the second PC5 link;
in response to the second ID and the RSC obtained by decrypting the second DCR being the same as the stored second ID and the stored RSC, respectively, determining to establish the second PC5 link;
in response to the second ID obtained by decrypting the second DCR being different from the stored second ID, determining to abort a second PC5 link establishment procedure;
in response to the RSC obtained by decrypting the second DCR being different from the stored RSC, determining to abort the second PC5 link establishment procedure; or
in response to the second ID and the RSC obtained by decrypting the second DCR being different from the stored second ID and the stored RSC, respectively, determining to abort the second PC5 link establishment procedure.

24. The method according to claim 22, wherein the second DCR comprises a layer 2 ID; and the method comprises:
in response to the layer 2 ID in the second DCR being the same as a stored layer 2 ID, determining the RSC corresponding to the layer 2 ID based on the layer 2 ID; and
determining the second key stream corresponding to the RSC based on the RSC.

25.-29. (canceled)
